(19) United States
(12) Patent Application Publication
(10) Pub. No.: US 2025/0044091 A1
(43) Pub. Date: Feb. 6, 2025

(54) ACCELEROMETER-TYPE BIAS CORRECTION ULTRACOLD ATOM SENSOR

(71) Applicant: THALES, MEUDON (FR)

(72) Inventors: Benjamin WIRTSCHAFTER, PALAISEAU (FR); Matthieu DUPONT-NIVET, PALAISEAU (FR); Soizic HELLO, Châtellerault (FR)

(21) Appl. No.: 18/792,315

(22) Filed: Aug. 1, 2024

(30) Foreign Application Priority Data
Aug. 3, 2023 (FR) 2308408

(51) Int. Cl. G01C 19/64

(52) U.S. Cl. CPC G01C 19/64

(57) ABSTRACT

An accelerometer-type interferometric ultracold atom inertial sensor including an atom chip including at least one set of a first and a second elementary sensor; an atom generation device; a generator for generating a uniform magnetic field; a power supply device; with the arrangement of the group of one or more conductive elements of each sensor and the sequence being further configured so that the trajectories associated with the first elementary sensor and the trajectories associated with the second elementary sensor are parallel to each other, are of the same length, are covered simultaneously and so that the departure direction of the first clouds, from the first and the second elementary sensor respectively, are opposite; the sensor further comprising a detection system.

### CROSS-REFERENCE TO RELATED APPLICATION

This application claims priority to foreign French patent application No. FR 2308408, filed on Aug. 3, 2023, the disclosure of which is incorporated by reference in its entirety.

### FIELD OF THE INVENTION

The present invention relates to the field of inertial sensors and more specifically to cold atom interferometric inertial sensors integrated on an atom chip. More specifically, the invention relates to accelerometer-type cold atom sensors on an atom chip using microwave fields for spatially separating two clouds of atoms according to two internal states, used when measuring the inertial acceleration parameter.

### BACKGROUND

In general, inertial sensors are devices for measuring physical parameters related to movement, such as accelerations or angular speeds, which, together with a clock, are used for bearing finding in a space. A device that measures acceleration and rotation speed is called an inertial unit or an inertial measurement unit (UMI).

Interferometry technology using cold atoms on a chip allows this type of inertial measurement to be carried out, and tends to be compact enough and to have sufficient performance capabilities to be used in embedded fields.

The operation of the cold atom accelerometer is based on interferometry, and measuring the phase difference of the interferometer can be used to derive an acceleration measurement.

A cold atom interferometer causes two electronic states, called first internal state |a> and second internal state |b>, of an atom, such as rubidium 87, to interfere in a Ramsey-type sequence. A Ramsey-type interferometer sequence measures a phase φ that is accumulated when implementing the sequence, from a measurement of at least one population of a selected state |a> or |b> (preferably a measurement of both populations for greater precision).

In order to make this interferometer sensitive to accelerations, the two states must both cover a straight return trajectory departing from the same departure point DP, with the two trajectories and the departure point being aligned along a straight line Dr. Thus, a term is added to the energy difference between the two states that depends on the difference in potential acceleration energy between the positions of the two states |a> and |b>, and therefore the phase of the interferometer depends on the acceleration.

The operating principle for measuring acceleration using interferometry, based on a clock type Ramsey sequence, where the phase of the interferometer at the end of the sequence is proportional to the energy difference between the two states of the interferometer, is briefly provided hereafter by way of a reminder.

In the case of a clock, the phase of the interferometer is provided by:

$${φ}_{c l o c k} = {φ}_{a} - {φ}_{b} = ( ω - {ω}_{a b} ) {T}_{R}$$

Where:
φₐ is the phase of the atoms in the |a> state, and φ_{b} is that of the atoms in the |b> state;

$${ω}_{a b} = {ω}_{0 a} - {ω}_{0 b}$$

ℏωₐ is the energy of the |a> state and ℏω_{b} is the energy of the |b> state;
ω_{ab} is the angular frequency corresponding to the energy difference between the |a> and |b> states;
ω is the angular frequency of the local oscillator;
T_{R} is the duration of free evolution (Ramsey time).

If, during this sequence, the atoms in the |a> state and those in the |b> state are each made to describe a straight return trajectory as described above, a phase shift term sensitive to the acceleration along the straight line Dr appears due to the difference in potential acceleration energy between the positions of the two states |a> and |b>: the clock becomes an accelerometer.

If the separation occurs along the X-axis (straight line Dr along X), and an acceleration ac is present throughout the duration Tₛₑ, over which the states are separated, then an additional phase shift appears at the output of the interferometer:

$${φ}_{a c c} = {φ}_{a} - {φ}_{b} = \frac{m}{ℏ} {\int }_{0}^{{T}_{s e p}} a c . ( {x}_{a} ( t ) - {x}_{b} ( t ) ) d t$$

Where:
xₐ(t) is the position of the |a> state along the straight line Dr and x_{b}(t) is the position of the |b> state along the straight line Dr;
   m is the mass of an atom and h is the reduced Planck constant.

Indeed, the energy levels of the two states of the interferometer have been energy shifted. This shift in energy levels is due to the spatial separation of the two states; as a result of their spatial separation, the two states are no longer at the same acceleration potential energy level.

In order to simplify the equation, the separation and recombination durations are considered to be negligible compared with the duration over which the separation is maintained (Tₛₑₚ≈T_{R}), xₐ and x_{b} are therefore no longer a function of time, and the previous equation can be re-written as follows:

$${φ}_{a c c} = \frac{m . a c . Δ x}{ℏ} {T}_{R} , with Δ x = {x}_{a} - {x}_{b}$$

The total phase output from the interferometer is therefore:

$${φ}_{tot} = {φ}_{c l o c k} + {φ}_{a c c} = \{ ω - ( {ω}_{a b} + \frac{m . a c . Δ x}{ℏ} ) \} {T}_{R} \qquad ( 1 )$$

Knowing this phase φₜₒₜ and the other quantities and parameters in formula (1) makes it possible to derive the acceleration along the X-axis.

The operating principle for an ultracold atom accelerometer based on an atom chip is provided hereafter by way of a reminder. It is used to generate the clouds of ultracold atoms and the trajectories enabling the acceleration to be measured via the phase, as described above.

Ultracold atoms are defined as atoms with a temperature that is lower than 400 nanokelvins, and preferably that is lower than 300 nanokelvins. The temperature of thermal ultracold atoms ranges, for example, for rubidium atoms, between 50 and 400 nanokelvins and preferably between 100 and 300 nanokelvins.

The principle involves creating two aligned and straight return trajectories that are respectively covered by the two clouds of magnetically trapped atoms. The magnetic trap is moved along the trajectories by conductive wires/elements and microwave guides disposed on and in the atom chip.

An example of an atom chip is shown in FIG. 1.

The surface of the chip defines an XY-plane, or measurement plane 13, normal to a Z-axis.

The chip 1 comprises means adapted to generate a first ultracold atom trap T1 and a second ultracold atom trap T2, with a trap allowing a cloud of ultracold atoms to be immobilized in an internal state different from the other trap, at a predetermined distance h from the measurement plane 13. For example, the trap T1 comprises the atoms in the electron level or |a> state (cloud CL1) and the trap T2 comprises the atoms in the |b> state (cloud CL2). The levels |a> and |b> are spaced apart by a frequency ω_{ab}/2π. For example, in the case of rubidium 87, two hyperfine levels are involved |F=1, m_{-F}=−1> and |F=2, m_{-F}=1>, spaced apart by approximately 6.8 GHz.

These means also allow the clouds to be moved along the trajectories TR1 and TR2 located in a plane parallel to the measurement plane 13, at a height h from this plane, as illustrated in FIG. 1. These means are made up of waveguides and conductive wires.

The waveguides CPW1 and CPW2 are suitable for propagating microwaves at angular frequencies ω_{b} and ωₐ. The waveguides are disposed symmetrically, preferably parallel, relative to a Y-axis of the measurement plane. The two waveguides CPW1 and CPW2 are connected to at least one generator for generating voltage or current at microwave frequencies. For example, each of the waveguides is produced by depositing three conductive wires in parallel so as to form a coplanar waveguide. In other embodiments, other types of waveguides can be used, in particular waveguides that are manufactured so as to be compatible with deposition or etching microfabrication techniques. A micro-strip line can be produced, for example.

The conductive wires that are integrated into the chip 1 are adapted for circulating direct currents. The conductive wires are divided, for example, into a conductive wire Wlz along an axis of symmetry Y perpendicular to X and lying in the measurement plane 13, and a conductive wire Wld parallel to the X-axis. The wires are arranged so as to define a crossing point C (crossing between Wlz and Wld) located on the Y-axis.

Each conductive wire is connected to one or more current and/or voltage generators, themselves connected to a processing unit comprising at least one microprocessor. The voltage and/or current generators allow both direct currents and alternating currents to be driven through the wires. In particular, direct currents are driven through the conductive wires.

In the sensor, the atom chip 1 is placed in a vacuum chamber, the vacuum of which is maintained, for example, using an ion pump and which preferably comprises magnetic shielding. The sensor comprises an ultracold atom generation device that comprises:
an atom dispenser, for example produced by a heated filament that generates a rubidium vapour;
a primary (optical and/or magnetic) atom trap, allowing a cloud of ultracold atoms to be pre-cooled and disposed in the vicinity of the chip, with a view to loading the magnetic traps T1 and T2 described below with atoms.

The sensor also comprises a magnetic field source, outside the chip 1. It allows a uniform and static magnetic field Bc to be generated over a thickness at least of the order of a height h above the measurement plane 13. Advantageously, the direction of the uniform magnetic field is parallel to the measurement plane.

In FIG. 1, the trajectories TR1 and TR2 shown as dashed lines respectively illustrate the trajectory of the clouds of ultracold atoms CL1 and CL2. A distance h separates the plane of the trajectories and the measurement plane 13 of the chip. Preferably, h ranges between 500 nm and 1 mm, and preferably between 5 μm and 500 μm.

FIG. 2 illustrates the geometry of the guides and wires of the atom chip, as well as the traps T1 and T2. The specific arrangement of the conductive wires and of the waveguides, in association with the uniform magnetic field source, allows two traps T1 and T2 as illustrated in part a) of FIG. 2 to be easily obtained. Each trap T1 and T2 has the same non-zero minimum value V0, and an identical curvature, which is a necessary condition in order for the sensor to operate. Indeed, when a direct current is applied to the two conductive wires crossing at C, the minimum of the potential is located vertically from this crossing point. When microwave power is then sent through the waveguides, the central minimum is converted into two minima that are located on either side of the initial minimum towards the waveguides. If the initial minimum is not located strictly at an equal distance from the two waveguides, the two created potential minima will not have strictly the same minimum value V0 and the same curvature.

Part c) of FIG. 2 illustrates the layout of the conductive wires defining the initial crossing point C and of the waveguides (seen from above). Part b) of FIG. 2 describes the corresponding layout of the conductive wires and of the waveguides printed on a chip as a profile section view, through the conductive wire Wld, which intersects the conductive wire Wlz along the axis of symmetry Y. The waveguides CPW1 and CPW2 are coplanar waveguides located on a first level N1. The isolating layer 18 advantageously allows the measurement plane to be flattened. The material of the electrically isolating layer can be, for example, silicon dioxide, silicon nitride or benzocyclobutene. A conductive material, gold for example, is used to manufacture the conductive wires, and is deposited onto a substrate 15, forming a second level N2. The substrate can be made, for example, of silicon, of aluminium nitride or of silicon carbide.

Part a) shows the symmetrical separation of ultracold atoms, which is specific to the internal state of the ultracold atoms, and more specifically shows the variations in potential as a function of the X-axis of the chip 1.

Curve “a” shows a potential well corresponding to the association of the uniform magnetic field and of the field created by the two intersecting conductive wires, namely the wire Wlz passed through by the current I_{Z} and the wire Wld passed through by the current Id. This results in a local potential well, initial potential Vini, forming a three-dimensional atom trap T. A cloud of ultracold atoms can be trapped therein and cooled.

Curve “b” schematically shows the potential created by transmitting microwaves at the frequency ω_{b} through the waveguide CPW1. The field emitted by the passage of microwaves at the frequency ω_{b} allows the energy of the ultracold atoms to be modified and the atoms of internal states |b> to be moved. Curve “e” illustrates the potential seen by the internal states |b> as a result of the contributions of the potentials illustrated by curve “a” and by curve “b”. Curve “e” has a local potential minimum allowing a cloud of ultracold atoms of internal states |b> to be trapped locally.

Similarly, curve “d” schematically shows the potential created by transmitting microwaves at the frequency ωₐ through the waveguide CPW2. The field emitted by the passage of microwaves at the frequency ωₐ allows the energy of the ultracold atoms to be modified and the atoms of internal states |a> to be moved. Curve “c” illustrates the potential seen by the atoms of internal states |a> as a result of the contributions of the potentials illustrated by curve “a” and by curve “d”. Curve “c” has a local energy minimum allowing a cloud of ultracold atoms of internal states |a> to be trapped locally.

The association of a DC magnetic trap (created by the direct currents in the wires and the uniform field Bc) and of a microwave field creates what is called a “dressed” trap. The term “dressed” is understood to mean a trap that is at least partly created by a microwave, radiofrequency or optical oscillating field. The changes in microwave fields (power, frequency and guide in which they propagate) allow this dressed trap, and therefore the atoms, to be moved. The DC magnetic trap is shown in FIG. 2 by the curve a. The microwave field at ωₐ is shown in FIG. 2 by the curve d and the microwave field at ω_{b} is shown in FIG. 2 by the curve b. The dressed trap T1 (association of curves a and d) for the |a> state is shown by the curve c and the dressed trap T2 (association of curves a and b) for the |b> state is shown by the curve e.

The clouds of ultracold atoms of internal states |a> and |b> can be separated and trapped symmetrically relative to the axis of symmetry Y by simultaneously making waves of frequency ωₐ propagate through CPW2 and waves of frequency ω_{b} propagate through CPW1. In order to obtain two traps with minima of the same value V0 and with curvatures of the same value, it is important for the crossing point C to be disposed at an equal distance from CPW1 and CPW2, on the axis of symmetry Y.

The frequencies ωₐ and ω_{b} are selected as a function of the frequencies of the states |a> and |b>ω₀ₐ and ω_{0b}.

FIG. 3 illustrates, in the lower part b) thereof, an example of applying the various signals to the wires and guides according to the prior art in order to cover, in the case of an accelerometer-type sensor, the linear trajectories at the two traps T1 and T2 (and therefore at the two clouds of trapped atoms), and illustrates, in the upper part thereof a), the position of the two clouds corresponding to selected times. Thus, part a) of FIG. 3 schematically shows a sequence of the movement of each of the clouds of ultracold atoms at characteristic times t₁ to t₃. Part b) illustrates the sequence of the various currents applied to the conductive wires, of the powers applied to the waveguides and of the frequencies applied to the waveguides, at the times corresponding to those of part a). In the sequence shown in FIG. 3, the current I_{z} (not shown) flowing through Wlz is static and at a constant value. The current applied to Wld is also constant throughout the sequence.

In a step A0, there is a phase of preparing the atoms. A cloud of ultracold atoms is generated, including phases of dispensing said atoms, of cooling said atoms, of initializing said atoms in at least one internal state |a> and of trapping a cloud of said ultracold atoms in a local potential minimum, at a distance h from the measurement plane (trap T, curve “a” of FIG. 2, part a)). The height h is different from 0 because the uniform magnetic field Bc is non-zero. Trapping is achieved by applying direct currents in the wire Wlz and in the wire Wld (Vini generation). At the same time, a magnetic bias field Bc is applied parallel to the plane of the atom chip, which field superposes on the magnetic field created by the foregoing two wires. The cloud of atoms is then trapped by the potential Vini vertical to C, which is the intersection of the wires Wlz and Wld. This step is illustrated by the part between 0 and t₁ in FIG. 3, part b).

In a step B0, the internal states are initialized by coherently superposing the ultracold atoms between the states |a> and |b> via a first pulse π/2. This pulse can be produced by a laser, a microwave emitter, or more generally using a method whereby waves are emitted at a suitable transition frequency. Currents I_{Z} and I_{d} are respectively applied to the conductive wires Wlz and Wld. The two internal states |a> and |b> are superposed coherently and spatially plumb with the crossing point C.

In a step C0, the initial cloud is spatially separated into a first cloud of ultracold atoms CL1 in a first internal state |a> from a second cloud of ultracold atoms CL2 in a second internal state |b>, forming a first ultracold atom trap T1 and a second trap T2. This step is illustrated by the part between t₁ and t′₁ in FIG. 3, part b).

In a step DO, the separation of the two traps is maintained for a time T_{S} (t′₁ to t′₂) and then the traps are recombined at said departure point (t′₂ to t₃).

During steps C0 and D0 the two clouds respectively cover a first linear trajectory TR1 and a second linear trajectory TR2 parallel to the XY-plane from the departure point DP.

In a step E0, the internal states |a> and |b> are recombined by applying a second pulse π/2 to the ultracold atoms, which transfers the phase difference to the populations of the two atomic levels. The pulses π/2 can be sent to the atoms via the microwave guides or via a separate microwave emitter.

The sequence ranging from the first pulse to the second pulse π/2 inclusive is the Ramsey sequence (see above).

Then, in a step F0, the phase due to the difference in potential acceleration energy between the two states |a> and |b> of the ultracold atoms is measured and the acceleration of the sensor along the X-axis is computed.

Considering only the Ramsey sequence of duration T_{R} between t₁ and t₃, initially at t₁ no power is applied to the waveguides and the cloud is trapped above point C. Between t₁ and t′₁, the microwave power injected into the waveguides CPW1 and CPW2 gradually increases from 0 to its maximum value, then the value remains maximum and constant between t′₁ and t′₂ passing through t₂. An angular frequency ωₐ is sent through the waveguide CPW2 and an angular frequency ω_{b} is sent through the waveguide CPW1, separating the two clouds with different internal states on either side of the axis of symmetry Y up to the positions schematically shown at t₂, with these positions being maintained throughout the duration t′₂-t′₁, which can be short. Between t′₂ and t₃, the microwave power in the waveguides is gradually cut. The two traps T1 and T2 move until they merge into a single trap located at the departure point schematically shown at t₃ (part a)).

In order to implement the method described above, the ultracold atom sensor allowing an acceleration measurement ac comprises:
an atom chip 1 as described above, with the waveguides and the conductive wires; an atom generation device for generating the cloud of ultracold atoms close to the measurement plane 13 of the atom chip;
a generator for generating the uniform magnetic field Bc;
at least one direct current or voltage generator suitable for controlling electric currents in the conductive wires and at least one generator for generating microwave current or voltage connected to the waveguides;
a detection system, typically for detecting an optical intensity, that is suitable for measuring at least one population of ultracold atoms in an internal state, with this measurement allowing the phase due to the difference in potential acceleration energy between the two states |a> and |b>, and therefore the acceleration ac, to be determined.

In order to obtain a more accurate measurement of the inertial parameters (time, acceleration, rotation speed), measurement redundancy can be used.

Architectures integrating several sensors, clocks, accelerometers and gyrometers are described in document US 2023/0178262. The sensor is based on an AchM0 matrix-array chip allowing several elementary sensors to be produced.

FIG. 4 illustrates an example of a 6×6 matrix from this document. The waveguides along 6 axes Xn and along 6 axes Ym form the columns and rows of the matrix. Each pixel (n,m) of the matrix corresponds to a potential elementary sensor that can be configured as required. For example, the chips in column C1 measure the acceleration along X ax, the chips in column C2 measure the rotation speed about the axis Y Ωy, the chips in row L1 measure the acceleration along Y ay and the chips in row L2 measure the rotation speed about the axis X Ωx. As a measurement requires a particular sequence for the coplanar guides, said guides cannot be shared for two simultaneous measurements of two distinct inertial parameters. Thus, the pixels 4 surrounded by a circle are not used. The matrix-array chip is thus reconfigured as required: the desired type of measurement (ax, ay, Ωx, Ωy, t), the desired accuracy (which depends on the number of chips simultaneously taking the measurement), etc. Parallel, redundant and/or complementary measurements are thus carried out on the same matrix-array chip. It should be noted that a measurement of Oz is also possible with a particular sequence for applying direct currents and/or the magnetic field and/or microwave fields, with an adapted chip topology if necessary (see, for example, documents US 2023/0178262 and US 2022/0397396).

FIG. 4bis illustrates another example of a 6×6 matrix from document US 2023/0178262 in which the waveguides form the diagonals, numbered (D1 to D6, then D1′ to . . . ). The rows and columns are formed by the DC wires W1n and W2m. Pixels on the South East-North West diagonal D5 measure ax, some pixels on diagonal D6 measure Ωy. The South West-North East diagonal D6′ measures Ωx, and the South West-North East diagonal D7′ measures ay. Thus, the elementary chips 5 surrounded by a circle are not used for the same reasons as above.

Sensors based on a matrix-array chip comprising a plurality of elementary sensors in the various geometries described above allow:
the clock function, the measurement of acceleration along two orthogonal axes and the measurement of rotations along three orthogonal axes in pairs to be implemented on a single chip;
elementary geometry to be duplicated on the same atom chip in order to carry out all the aforementioned measurements at the same time and to implement redundancy between the various measurements.

However, this solution does not allow measurement bias to be eliminated or errors to be corrected.

Every measurement has an associated uncertainty, which is expressed by an error in the measurement. This error can be due to random factors that are unavoidable and cannot be corrected (although their magnitude can be estimated), but also can be due to systematic factors due to sensor imperfections or imperfect measurement conditions. This latter type of error is also known as bias.

### SUMMARY OF THE INVENTION

An aim of the present invention is to overcome the aforementioned disadvantages by proposing an accelerometer-type inertial sensor and a measurement method that allows some biases to be corrected, in order to improve the performance capabilities of the sensor.

The aim of the present invention is an accelerometer-type interferometric ultracold atom inertial sensor comprising:
an atom chip placed in a vacuum chamber, comprising an XY-plane, called measurement plane, normal to a Z-axis, and comprising at least one set of a first and a second elementary sensor, with each elementary sensor comprising:
   at least one first pair of waveguides parallel to each other and at least one second pair of waveguides parallel to each other and intersecting the first pair;
   a group of one or more conductive elements;
an atom generation device configured to generate an initial cloud of ultracold atoms associated with the first elementary sensor and an initial cloud of ultracold atoms associated with the second elementary sensor, with said initial clouds being located close to said XY-plane of said chip;
a generator for generating a uniform magnetic field (Bc);
a power supply device comprising at least one microwave generator and at least one direct current generator, the power supply device being configured to apply microwave signals to said waveguides and direct currents to said conductive elements;
the magnetic field generator and the power supply device being configured to apply the magnetic field, the direct currents and the microwave signals in a predetermined sequence;
with an arrangement of said group of one or more conductive elements and said sequence being configured, when implementing each sensor, to:
   i) generate an initial trapping potential for said initial cloud of ultracold atoms defining a departure point;
   ii) spatially separate the initial cloud into a first cloud of ultracold atoms in a first internal state and a second cloud of ultracold atoms in a second internal state, by respectively forming a first and second ultracold atom trap, and such that the first cloud, the second cloud and the departure point are aligned along a measurement axis;
   iii) maintain the separation of said first and second traps for a time T_{S}, and then recombine said traps at said departure point, such that said first and second clouds respectively cover a first and a second linear trajectory parallel to the XY-plane from the departure point;
with the arrangement of said group of one or more conductive elements of each sensor and said sequence being further configured so that the trajectories associated with the first elementary sensor and the trajectories associated with the second elementary sensor are parallel to each other, are of the same length, are covered simultaneously and so that the departure direction of the first clouds, from the first and the second elementary sensor respectively, are opposite;
the sensor further comprising a detection system adapted to measure at least a first phase of the first elementary sensor and a second phase of the second elementary sensor, with an acceleration being determined from a difference between the first and the second phase.

According to one embodiment, the power supply device PSD is further configured to apply direct currents to said waveguides.

According to one embodiment, the first and the second pair of waveguides are perpendicular to each other, and the sensor comprises at least two assemblies configured to respectively carry out an acceleration measurement along two orthogonal axes.

According to one embodiment, the atom chip has a matrix structure, the pixels of which define potential elementary sensors, with a set comprising two pixels of the matrix.

According to one embodiment, sets of a first and a second elementary sensor have at least one conductive element in common.

According to another aspect, the invention relates to an inertial unit comprising at least two accelerometer-type sensors according to the invention configured to respectively carry out an acceleration measurement along two orthogonal axes, with the matrix atom chip further comprising pixels configured to carry out at least one clock measurement and pixels configured to carry out rotation speed measurements along three orthogonal axes.

According to another aspect, the invention also relates to a method for measuring an acceleration using an interferometric ultracold atom inertial sensor comprising an atom chip placed in a vacuum chamber, comprising an XY-plane, called measurement plane, normal to a Z-axis, and comprising at least one set of a first and a second elementary sensor, with each elementary sensor comprising:
at least one first pair of waveguides parallel to each other and at least one second pair of waveguides parallel to each other and intersecting the first pair;
a group of one or more conductive elements;
   the method comprising the following steps:
A. generating an initial cloud of ultracold atoms associated with the first elementary sensor and an initial cloud of ultracold atoms associated with the second elementary sensor, with said initial clouds being located close to said XY-plane of said chip;
B. generating a uniform magnetic field;
C. generating, for each sensor, an initial trapping potential for said initial cloud of ultracold atoms;
D. initializing, for each sensor, a first internal state and a second internal state via a first pulse π/2;
E. spatially separating, for each sensor, the initial cloud into a first cloud of ultracold atoms in the first internal state and a second cloud of ultracold atoms in the second internal state, by respectively forming a first and second ultracold atom trap, and such that the first cloud, the second cloud and the departure point are aligned along a measurement axis;
F. maintaining, for each sensor, the separation of said first and second traps for a time T_{S}, and then recombining said traps at said departure point, such that said first and second clouds respectively cover a first and a second linear trajectory parallel to the XY-plane from the departure point;
   with steps B to F being carried out by applying, in a predetermined sequence, a uniform magnetic field, as well as direct currents to said conductive elements and microwave signals (I_{MW}) to said waveguides;
   with the arrangement of said group of one or more conductive elements and said predetermined sequence being further configured so that the trajectories associated with the first elementary sensor and the trajectories associated with the second elementary sensor are parallel to each other, are of the same length, are covered simultaneously and so that the departure direction of the first clouds, from the first and the second sensor respectively, are opposite;
G. recombining said first and second internal states by applying a second pulse π/2 to said ultracold atoms;
H. measuring at least a first phase of the first elementary sensor and a second phase of the second elementary sensor, with an acceleration being determined from a difference between the first and the second phase.

According to one embodiment, step C comprises applying direct currents to at least one conductive element.

According to one embodiment, step E and step F involve applying microwave signals in a pair of waveguides in order to measure an acceleration along a measurement axis perpendicular to the waveguides of said pair.

According to one embodiment, in step E and step F applying microwave signals comprises:
for the first elementary sensor, applying a signal of frequency ωₐ in one of the waveguides and applying a frequency ω_{b} in the other waveguide;
for the second sensor, applying a signal of frequency ω_{b} in one of the waveguides and applying a frequency ωₐ in the other waveguide;
with said frequencies ωₐ and ω_{b} being determined from the resonant frequencies of said first and second internal states.

According to one embodiment, step F comprises a sub-step of cutting off microwave signals and a sub-step of applying direct currents to said waveguides.

The following description presents several embodiments of the device of the invention: these examples do not limit the scope of the invention. These embodiments equally contain features that are essential to the invention as well as additional features associated with the considered embodiments.

### BRIEF DESCRIPTION OF THE DRAWINGS

The invention will be better understood and other features, aims and advantages thereof will become apparent throughout the following detailed description, which is provided with reference to the appended drawings, which are provided by way of non-limiting examples and in which:

FIG. 1 illustrates an example of an atom chip according to the prior art;

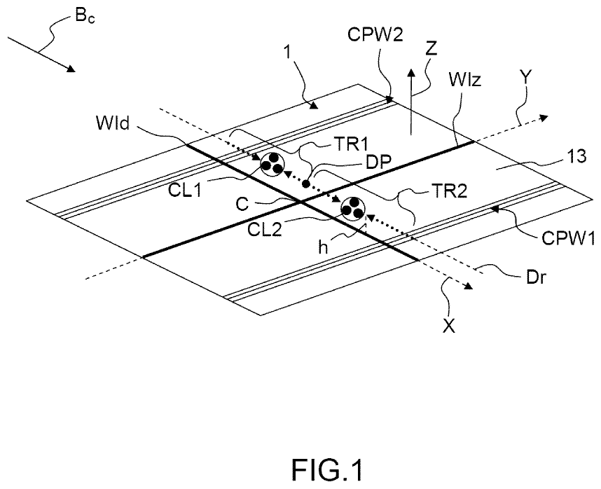

FIG. 2 illustrates the geometry of the guides and wires of an atom chip according to the prior art, as well as the magnetic traps;

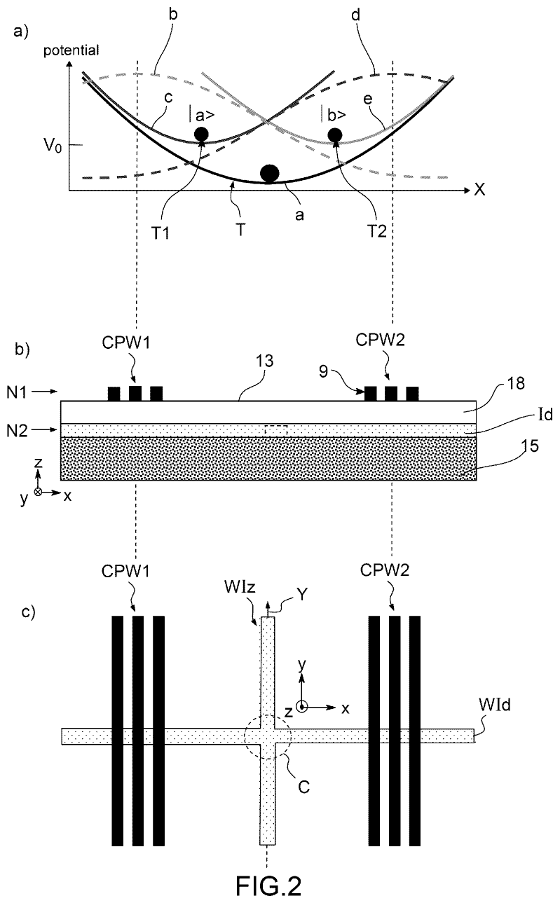

FIG. 3 illustrates, in the lower part b) thereof, an example of applying the various signals to the wires and guides according to the prior art in order to cover, in the case of an accelerometer-type sensor, the linear trajectories at the two traps, and illustrates, in the upper part thereof a), the position of the two clouds corresponding to selected times;

FIG. 4 illustrates a first alternative embodiment of a matrix-array chip according to the prior art for producing several elementary sensors;

FIG. 4bis illustrates a second alternative embodiment of a matrix-array chip according to the prior art for producing several elementary sensors;

FIG. 5 illustrates the principle of the sensor according to the invention, which comprises a first elementary sensor illustrated in part a) and a second elementary sensor illustrated in part b);

FIG. 6 illustrates the time sequence of the measurements taken with the two sensors, namely SENA for the upper part a) and SENB for the lower part b);

FIG. 7 illustrates the accelerometer-type ultracold atom interferometric inertial sensor according to the invention;

FIG. 8 illustrates an example of a chip topology comprising two intersecting strips compatible with the production of elementary sensors according to the invention;

FIG. 9 illustrates another example of chip topology comprising a flared wire compatible with the production of elementary sensors according to the invention;

FIG. 10 illustrates an example of the implementation for taking two acceleration measurements along the same axis, using two elementary sensors on the same chip according to the invention. For greater clarity, only one pair of guides is shown, namely, the guides parallel to the Y-axis, for measuring an acceleration along the X-axis.

### DETAILED DESCRIPTION

The idea of the invention is to use two elementary sensors particularly configured to eliminate measurement bias.

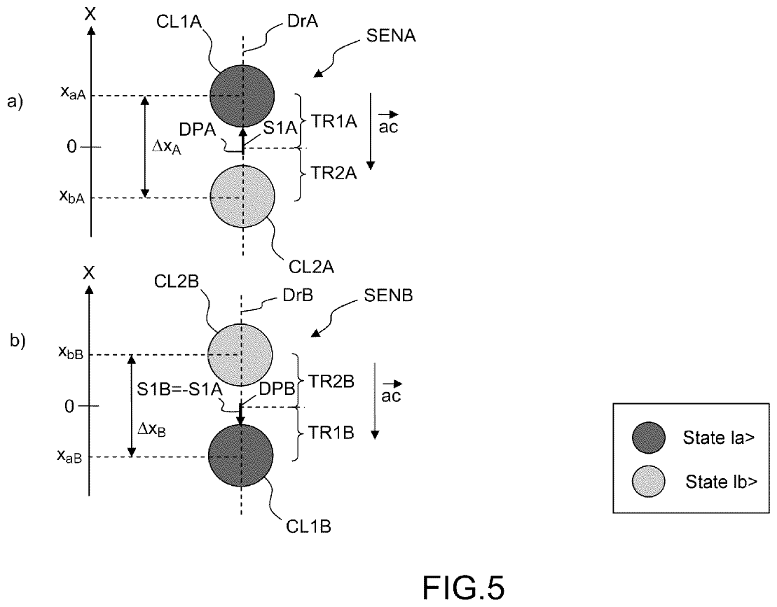

The formula (1) set forth above corresponds, for example, to a sensor SENA for which the trajectory TR1A is covered by the cloud CL1 and the trajectory TR2A is covered by the cloud CL2, as illustrated in the upper part a) of FIG. 5. The cloud CL1A departs from the departure point DPA in a departure direction S1A (and the cloud CL2A departs from the departure point in a departure direction S2A not shown in FIG. 5). In FIG. 5a) the departure direction S1A is upwards (the direction S2A is downwards). The abscissas of the end points of the trajectories TR1A (cloud CL1A in state |a>) and TR2A (cloud CL2A in state |b>) of the sensor SENA are respectively denoted x_{aA} and x_{bA}, with Δx_{A}=|x_{aA}−x_{bA}|.

For an accelerometer, the sign of the phase shift induced by the presence of an acceleration during the interferometry phase depends on how the two clouds of atoms cover the two trajectories. The sign of the phase shift depends on the direction in which the two clouds leave the departure point.

Two cold atom accelerometers, SENA and SENB, are considered that are disposed on the same chip with the traps being separated using a displaceable trapping potential, each oriented so that it is sensitive to accelerations along the same axis (for example, the X-axis in the example). This means that the straight line DrA on which the trajectories TR1A and TR2A of the sensor SENA are based and the straight line DrB on which the trajectories TR1B and TR2B of the sensor SENB are based are parallel to each other and to X. The abscissas of the end points of the trajectories TR1B (cloud CL1B in state |a>) and TR2B (cloud CL2B in state |b>) of the sensor SENB are respectively denoted x_{bB} and x_{aB}, with Δx_{b}=|x_{bB}−x_{aB}| (see part b) of FIG. 5).

Assuming that, for the sensor SENB, the departure direction S1B of the first cloud CL1B is opposite the departure direction S1A of the first cloud CL1A of the sensor SENA, then S1B=−S1A, i.e. the first cloud CL1B in this case departs downwards. Of course, this condition is also met for the second clouds CL2A and CL2B. This is illustrated in the lower part b) of FIG. 5. The cloud CL1B departing from the departure point DPB towards S1B departs downwards.

When the directions of travel of the atomic states used on these sensors are inverted, as shown in FIG. 5, each accelerometer will accumulate the same phase shift to the nearest sign difference.

This result is obtained for trajectories that are parallel to each other, are of the same length and are covered simultaneously, and so that the departure direction of the clouds CL1A and CL1B are opposite: Δx_{A}=Δx_{B}=ΔX.

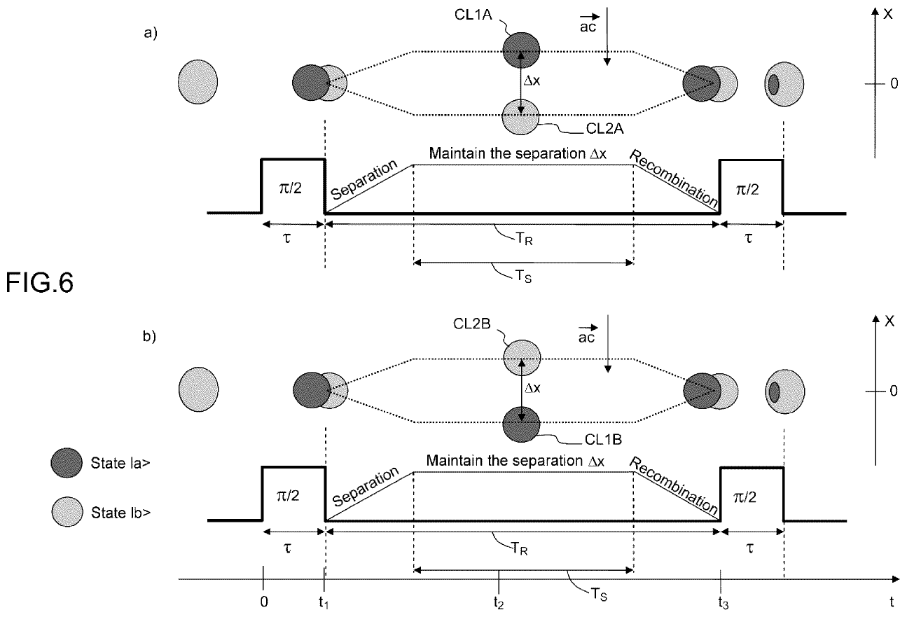

FIG. 6 illustrates the time sequence of the measurements taken with the two sensors, namely SENA for the upper part a) and SENB for the lower part b). After a first pulse π/2 (duration T), the two pairs of clouds are simultaneously separated from t₁ (start of the Ramsey sequence), and are then kept separate for a time T_{S}, and are then recombined. Finally, a second pulse π/2 ends the Ramsay sequence, of total duration T_{R}. By simultaneously taking two measurements (one for each sensor), it is possible to eliminate the presence of measurement bias, as explained hereafter.

Let φ_{tot_SA} be the phase accumulated during the interferometric sequence corresponding to FIG. 5, part a) and φ_{tot_SB} be the phase accumulated during the interferometric sequence corresponding to FIG. 5, part b). Using formula (1), then:

$${φ}_{tot \_ SA} = {φ}_{c l o c k} + {φ}_{a c c} = \{ ω - ( {ω}_{a b} + \frac{m . a c . Δ x}{ℏ} ) \} {T}_{R} \qquad ( 2 A )$$

$${φ}_{tot \_ SB} = {φ}_{c l o c k} - {φ}_{a c c} = \{ ω - ( {ω}_{a b} - \frac{m . a c . Δ x}{ℏ} ) \} {T}_{R} \qquad ( 2 B )$$

Assuming the measurement is affected by a bias, then:

$${φ}_{tot \_ SA} = {φ}_{c l o c k} + {φ}_{a c c} + {φ}_{b i a s}$$

$${φ}_{tot \_ SB} = {φ}_{c l ock} - {φ}_{a c c} + {φ}_{b i a s}$$

With φ_{bias} being the additional phase due to the bias present in any measurement (called “additive” bias).

If a (non-negligible) bias is present, determining φ_{tot_SA}−φ_{tot_SB} eliminates:

$${φ}_{a c c} = \frac{1}{2} ( {φ}_{tot \_ SA} - {φ}_{tot \_ SB} ) \qquad ( 3 )$$

Thus, in order to carry out a measurement that eliminates the bias, two interferometric sequences must be carried out at the same time using two sensors on the same chip.

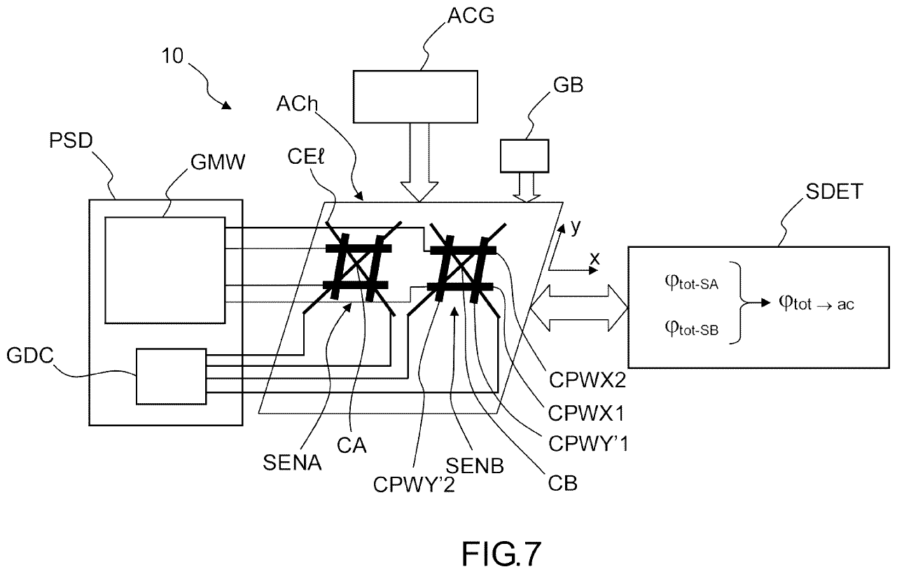

The ultracold atom interferometric inertial sensor 10 according to the invention uses this property and is illustrated in FIG. 7. It comprises an atom chip ACh placed in a vacuum chamber, comprising an XY-plane, called measurement plane, normal to the Z-axis. The chip comprises at least one set of a first elementary sensor SENA and a second elementary sensor SENB. Each elementary sensor comprises at least one first pair of waveguides (CPWX1, CPWX2) parallel to each other and at least one second pair of waveguides (CPWY′1, CPWY′2) parallel to each other and intersecting the first pair. The intersection of the two pairs defines a parallelogram. The atom chip also comprises a group of one or more conductive elements CEI.

The sensor further comprises an atom generation device ACG configured to generate an initial cloud of ultracold atoms associated with the first elementary sensor SENA and an initial cloud CLB of ultracold atoms associated with the second elementary sensor SENB. The initial clouds are located close to said XY-plane of the chip. The sensor also comprises a generator GB for generating a uniform magnetic field Bc and a power supply device PSD. The power supply device comprises at least one microwave generator GMW configured to apply microwave signals to the waveguides and at least one direct current generator configured to apply direct currents to the conductive elements. The magnetic field generator GB and the power supply device PSD are configured to apply the magnetic field Bc, the direct currents and the microwave signals in a predetermined sequence.

The arrangement of the group of one or more conductive elements and the predetermined sequence are configured, when each sensor is implemented, to carry out the various steps described above on the clouds.

This initially involves generating an initial trapping potential Vini of said initial cloud of ultracold atoms, then spatially separating the initial cloud into a first cloud of ultracold atoms (CL1A for SENA and CL1B for SNEB) in a first internal state and a second cloud of ultracold atoms (CL2A for SENA and CL2B for SENB) in a second internal state, respectively forming a first trap of ultracold atoms (T1A for SENA and T1B for SENB) and a second trap of ultracold atoms (T2A for SENA and T2B for SENB). In addition, the first cloud, the second cloud and the departure point are aligned along a measurement axis:
departure point DPA for SENA with CL1A, DPA and CL2A aligned along the straight line DrA;
departure point DPB for SENB with CL1B, DPB and CL2B aligned along the straight line DrB.

The departure points DPA for SENA and DPB for SENB are preferably located at the centre of the parallelogram, which is a rectangle when the pairs are perpendicular (axis Y′=Y).

As illustrated in FIG. 5, for each sensor the first cloud, the second cloud and the departure point are aligned along a measurement axis.

The separation of the first and second traps is then maintained for a time Ts, and the traps are then recombined at the departure point, so that the first and second clouds respectively cover a first and a second linear trajectory parallel to the XY-plane from the departure point.

The arrangement of the group of one or more conductive elements of each sensor and the sequence for applying direct currents in the conductive elements, microwave signals in the guides and the magnetic field in the vicinity of the atom chip Ach are further configured so that the trajectories (TR1A and TR2A) associated with the first elementary sensor and the trajectories (TR1B and TR2B) associated with the second elementary sensor are parallel to each other, are of the same length and are covered simultaneously. In addition, the departure direction of the first clouds, from the first and the second elementary sensor respectively, are opposite. If S1A is the departure direction of CL1A and S2A is the departure direction of CL1B, then S1B=−S1A. The same condition is also met for the second clouds CL2A and CL2B.

The sensor further comprises a detection system SDET adapted to measure at least a first phase φ_{tot_SA} of the first elementary sensor and a second phase φ_{tot_SB} of the second elementary sensor. The acceleration ac is determined from a difference between the first and the second phase (property expressed with formula (3)). When the sensor according to the invention is used, a dual simultaneous measurement of the same parameter, the phase accumulated during the interferometric sequence, is therefore carried out.

By using the property of the interferometer explained by the formulae (2A) (2B) and (3), the acceleration determined in this way is corrected for the “additive” bias that affects each measurement in the same way. This reduction in measurement bias leads to reduced measurement uncertainty for the accelerometer according to the invention, i.e. improved sensitivity, which allows longer inertial navigation times to be obtained.

Preferably, the first and the second pair of waveguides are perpendicular to each other. For example, the guides of the first pair are parallel to the X-axis and the guides of the second pair are parallel to the Y′=Y-axis. The set of two accelerometers (SENA and SENB) is thus able to measure accelerations along two orthogonal axes. They measure either of the accelerations without bias depending on the sequence that is applied.

According to one embodiment, the sensor comprises at least two assemblies respectively configured to measure acceleration along two orthogonal axes. Thus, the measurement of the acceleration acx along X without bias is carried out by the first assembly and the measurement of acy along Y without bias is carried out by the second assembly. The measurements of acx and acy without bias thus can be carried out simultaneously.

The sensor according to the invention is compatible with any atom chip geometry comprising the two pairs of microwave guides for generating “dressed” traps (see the prior art), i.e. the generation of a trapping potential, and the selective separation of these traps as a function of the internal states along a linear trajectory as described above.

Thus, the conductive elements CEI of the chip can be arranged in different ways. Of importance is the generation of a trapping potential resulting from the combination of the DC fields generated by the conductive elements through which direct currents flow and the microwave fields generated by the waveguides through which microwave signals flow, with this trapping potential being able to be moved in order to create the separation and therefore the linear trajectory.

For example, the sensor according to the invention is compatible with all the chip geometries described in the prior art, associated with the various addressing modes, i.e. with particular sequences for applying the magnetic field, the direct currents and the microwave fields.

Conductive element geometries have been described for gyrometer applications. These geometries are applicable in this case as they allow separation of the two clouds from a departure point. The accelerometer does not require the traps to move along a closed trajectory.

Typically, according to the prior art, the initial trapping potential is generated by applying direct currents in the conductive elements.

According to one embodiment, these conductive elements are two wires that cross at point C, as illustrated in FIG. 7 (point CA for SENA and CB for SENB).

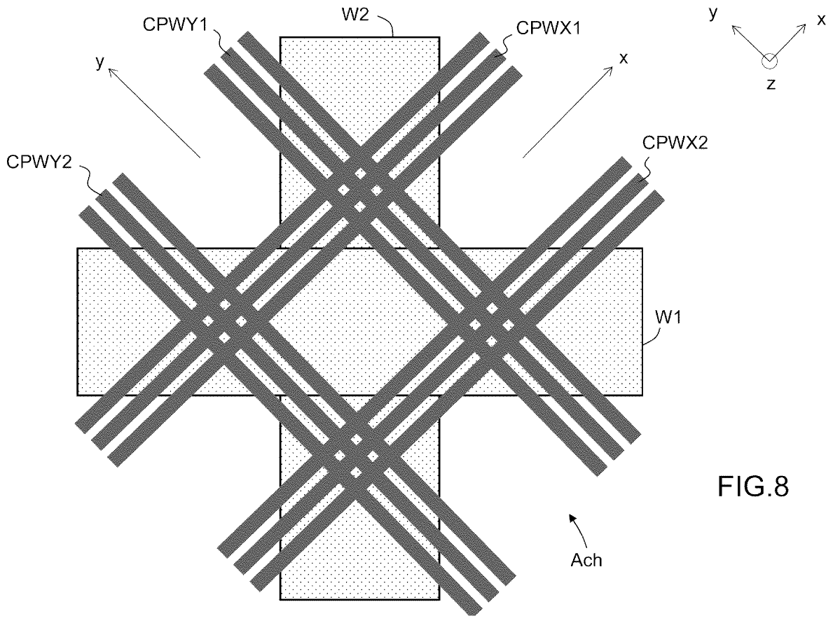

According to another embodiment, the conductive elements comprise two intersecting strips W1 and W2, as illustrated in FIG. 8 and described in document US 2022/0397397.

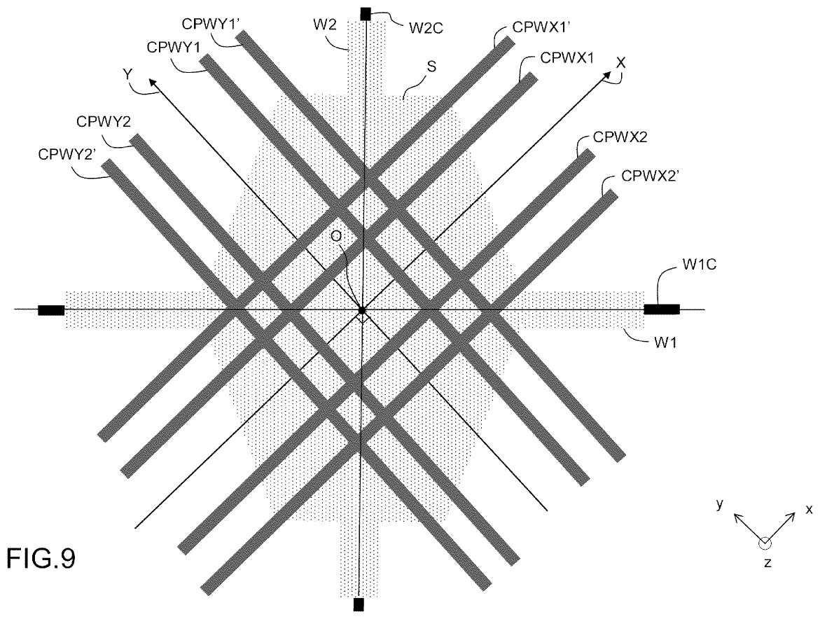

According to another embodiment, the conductive elements comprise a flared wire W2, as illustrated in FIG. 9 and described in document US 2022/0397396. The additional pairs of guides (CPWX1′, CPWX2′) and (CPWY1′, CPWY2′), the second wire W1 and the loading wires W1C and W2C illustrated in FIG. 9 are optional for the accelerometer according to the invention.

The two traps T1 and T2 are separated by applying microwave signals to the various waveguides.

According to one embodiment, the separation is maintained by keeping the microwave signals on the various waveguides.

According to another embodiment, once the clouds are separated, the microwave signals applied to the waveguides are replaced by direct currents. This embodiment is described for the gyrometer application in document FR 2306475 (not yet published on the filing date). In this case, the power supply device PSD is also configured to apply direct currents to the waveguides. This replacement allows the measurement noise to be reduced.

The sensor according to the invention is thus independent of the geometry of the atom chip and the method used to maintain the traps. The chip can assume another geometry of conductive elements associated with the waveguides that is not described in the aforementioned documents, as well as additional waveguides. The implementation of the sensor can use separation/retention methods (sequences) for producing a displaceable trapping potential (i.e. the minimum of which can be displaced) other than those described in the aforementioned documents.

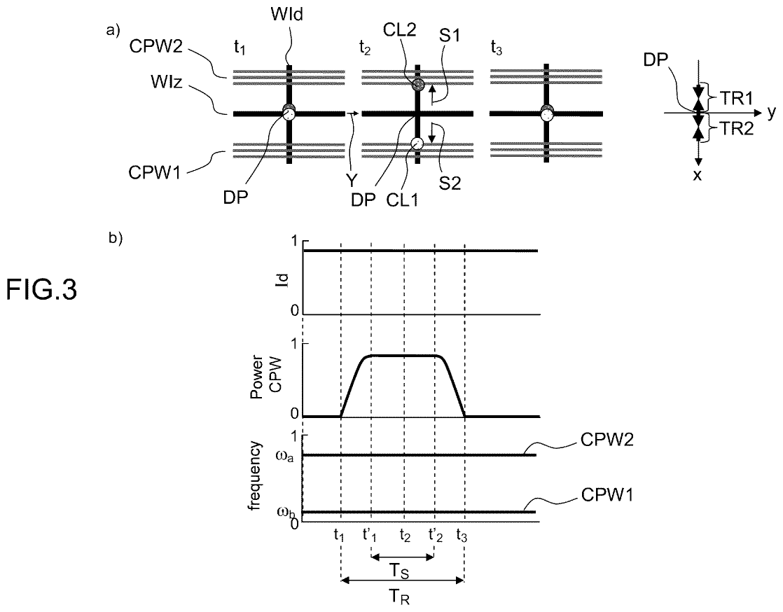

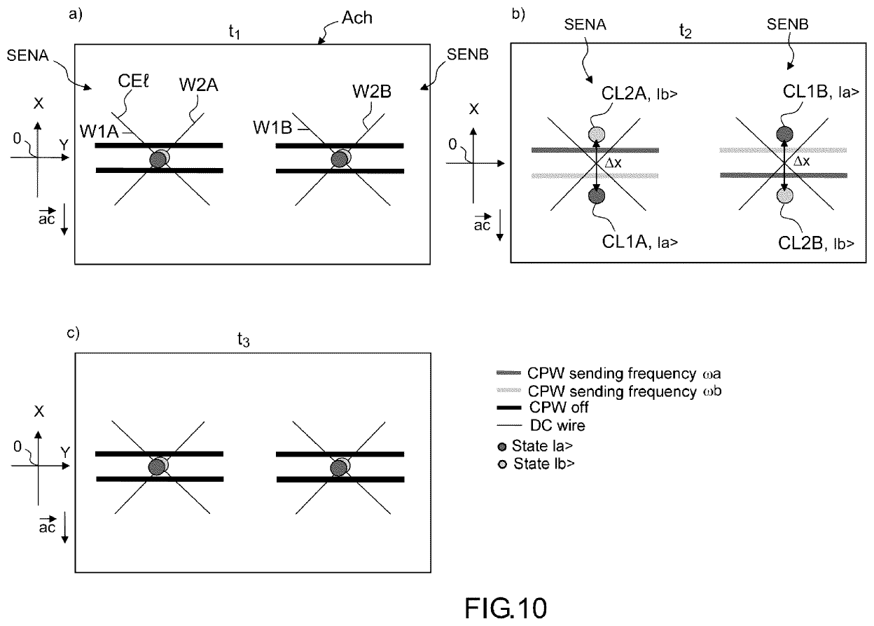

In practice, an example of the implementation of two acceleration measurements along the same axis, using two elementary sensors on the same chip by moving each state antisymmetrically, is illustrated in FIG. 10, which is based on the operating principle of an accelerometer illustrated in FIG. 3. For greater clarity, only one pair of guides is shown, namely, the guides parallel to the Y-axis, for measuring an acceleration along the X-axis.

The potential Vini is generated for each sensor by two wires, (W1A and W2A) for SENA and (W1B and W2B) for SENB, through which direct currents flow. The two wires cross at a point disposed at an equal distance from the two guides. In this way, the DC wires of the same sensor (with an external bias field Bc) can be used to create a magnetic trap for manipulating and storing atoms, notably during the interferometry phase.

The coplanar waveguides allow, when a microwave signal is injected inside (at the correct power and frequency), the atoms to be selectively moved according to their current electronic state by pushing them.

FIG. 10 schematically shows various instants of the interferometry sequence in order to better show the displacements induced on the atomic states due to the various DC and microwave currents to be injected into the two sensors at the same time.

At t=0 the atoms of the sensor SENA are in the |a> state and those of the sensor SENB are also in the |a> state. The cloud of each of the sensors was prepared under the same conditions so that they would have the same properties (number of atoms, temperature, state, etc.). Each sensor has a cloud of atoms trapped inside a magnetic trap created by the two DC wires of the sensor corresponding thereto. The coplanar waveguides are currently switched off. The interferometry sequence for each sensor starts simultaneously and under the same conditions at t=0, with a pulse π/2 of duration T (for each sensor), ending at t₁, as shown in FIG. 6. This pulse will place each of the clouds into a coherent superposition with equal weights for the two states of the interferometer.

Between t₁ (part a) of FIG. 10) and t₂ (part b) of FIG. 10), the coplanar waveguides of the two sensors are gradually switched on, as shown in FIG. 10. Indeed, each state needs to be selectively moved in opposite directions. The subtlety lies in the frequencies used in the waveguides of each sensor:

In the coplanar waveguides of the sensor SENA (on the left), the microwave frequency ωₐ corresponding to the dressing of the |a> state is injected into the waveguide that is in the positive x positions, and the microwave frequency ω_{b} corresponding to the dressing of the |b> state is injected into the waveguide that is in the negative x positions.

In the coplanar waveguides of the sensor SENB (on the right), the microwave frequency ωₐ corresponding to the dressing of the |a> state is injected into the waveguide that is in the negative x positions, and the microwave frequency ω_{b} corresponding to the dressing of the |b> state is injected into the waveguide that is in the positive x positions.

Thus, the sensor SENA will therefore shift the |b> state to the positive x positions and the |a> state to the negative x positions, while the sensor SENB will shift the |a> state to the positive x positions and the |b> state to the negative x positions. The selective displacement of the states therefore occurs antisymmetrically between the two sensors, i.e. the departure directions of each type of cloud are opposite for the two sensors.

After a duration for maintaining the separation, at the instant t₃ (part c) in FIG. 10, the recombination of the clouds on the two sensors is completed by simultaneously turning off all the waveguides, and the second pulse π/2 can begin (one for each sensor).

Finally, all the magnetic fields are switched off in order to release the atoms and the populations of atoms of each sensor are detected in order to determine φ_{tot_SA} and φ_{tot_SB}, then to compute the acceleration according to X acx from (φ_{tot_SA}−φ_{tot_SB}) by eliminating the measurement bias.

Using the pair of guides along X (not shown in FIG. 10), the acceleration acy along the Y-axis is measured according to the same reasoning.

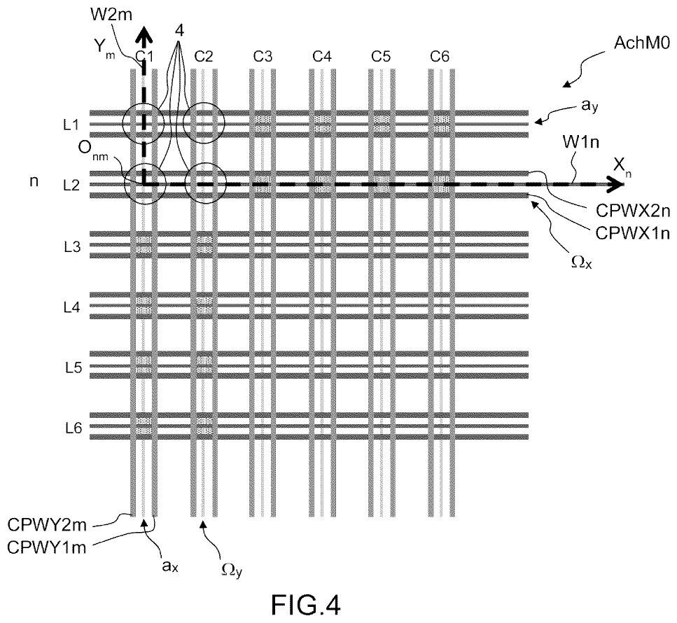

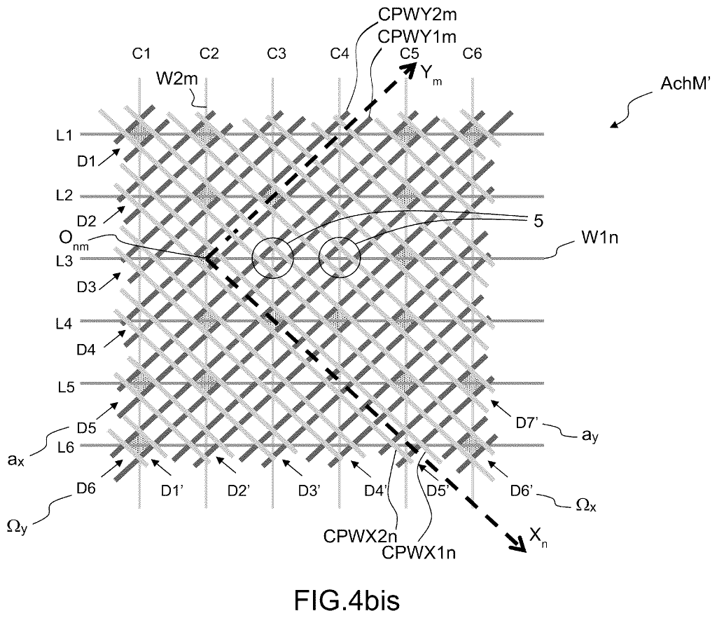

According to one embodiment, the atom chip has a matrix structure, the pixels of which define potential elementary sensors, a set of two sensors (SENA and SENB) comprising two pixels of the matrix. An example of a matrix-array chip topology is illustrated in FIG. 4, and another is illustrated in FIG. 4bis.

For the implementation of the invention, two pixels of the matrix are configured to form an assembly according to the invention for measuring an acceleration.

As various microwave signals are applied to the two sensors SENA and SENB, they cannot have common waveguides. According to one embodiment, sets of a first and a second elementary sensor have at least one conductive element in common. A topology according to FIG. 4bis is preferred in which the sensors SENA and SENB are selected in the matrix in order to share the same conductive wire but not the same waveguides.

According to another aspect, the invention relates to an inertial unit comprising at least two accelerometer-type sensors according to the invention configured to respectively carry out an acceleration measurement along two orthogonal axes, with the matrix atom chip further comprising pixels configured to carry out at least one clock measurement and pixels configured to carry out rotation speed measurements along three orthogonal axes.

According to another aspect, the invention relates to a method for measuring an acceleration using an interferometric ultracold atom sensor 10 according to the invention as described above.

The method comprises steps A to F for each sensor. In a step A, an initial cloud of ultracold atoms associated with the first elementary sensor SENA and an initial cloud CLB of ultracold atoms associated with the second elementary sensor SENB are generated, with the initial clouds being located close to said XY-plane of the chip. In a step B, a uniform magnetic field Bc is generated in the vicinity of the chip. Steps A and B can be simultaneous. In a step C, an initial trapping potential Vini of the initial cloud of ultracold atoms is generated (for each sensor). Then, for each sensor, in a step D, a first internal state and a second internal state are initialized by a first pulse π/2.

In a step E, for each sensor, the initial cloud is spatially separated into a first cloud (CL1A for SENA, CL1B for SENB) of ultracold atoms in the first internal state and a second cloud (CL2A for SNA, CL2B for SNB) of ultracold atoms in the second internal state, by respectively forming a first trap of ultracold atoms (T1A for SENA, T1B for SENB) and a second trap of ultracold atoms (T2A for SNA, T2B for SNB). For each sensor, the first cloud, the second cloud and the departure point are aligned along a measurement axis.

For each sensor, the separation of the first and second traps is maintained for a time Ts and then the traps are recombined at the departure point, so that the first and second clouds respectively cover a first linear trajectory (TR1A for SENA, TR1B for SENB) and a second linear trajectory (TR2A for SNA, TR2B for SNB) from the departure point. The trajectories are parallel to the XY-plane of the chip.

Steps B to F are carried out by applying, in a predetermined sequence, a uniform magnetic field in the vicinity of the chip, direct currents to conductive elements CEI and microwave signals S_{MW} to the waveguides.

In order to be able to measure the same phase with an opposite sign, the arrangement of the group of elements of one or more conductive elements and the predetermined sequence are further configured so that the trajectories (TR1A and TR2A) associated with the first elementary sensor and the trajectories (TR1B and TR2B) associated with the second elementary sensor are parallel to each other, are of the same length, are covered simultaneously, and such that the departure direction (i.e., departure from points DPA and DPB) of the first clouds CL1A and CL1B, respectively, from the first sensor SENA and the second sensor SENB are opposite.

Then, in a step G, the first and second internal states are recombined by applying a second pulse π/2 to said ultracold atoms. In a step H, at least a first phase φ_{tot_SA} of the first elementary sensor and a second phase φ_{tot_SB} of the second elementary sensor are measured, with the acceleration being determined from the difference between the first and the second phase.

According to one embodiment, step C comprises applying direct currents to at least one conductive element.

According to one embodiment, step E and step F comprise applying microwave signals in a pair of waveguides in order to measure an acceleration along a measurement axis perpendicular to the waveguides of the considered pair.

According to one embodiment, in step E and step F applying microwave signals comprises:
for the first elementary sensor SENA, applying a signal of frequency ωₐ in one of the waveguides and applying a frequency ω_{b} in the other waveguide;
for the second sensor SENB, applying a signal of frequency ω_{b} in one of the waveguides and applying a frequency ωₐ in the other waveguide.

The frequencies ωₐ and ω_{b} are determined from the resonant frequencies of the first and second internal states.

For the sensor SENB, the choice of which frequency to apply to which guide is determined in order to obtain the inversion of the departure directions relative to those of SNA.

According to one embodiment, in order to reduce the measurement noise, step F comprises a sub-step of cutting off microwave signals and a sub-step of applying direct currents to the waveguides instead of microwave signals.

1. An accelerometer-type interferometric ultracold atom inertial sensor comprising:
an atom chip (ACh) placed in a vacuum chamber, comprising an XY-plane, called measurement plane, normal to a Z-axis, and comprising at least one set of a first and a second elementary sensor (SENA, SENB), with each elementary sensor comprising:
at least one first pair of waveguides (CPWX1, CPWX2) parallel to each other and at least one second pair of waveguides (CPWY′₁, CPWY′₂) parallel to each other and intersecting with the first pair;
a group of one or more conductive elements;
an atom generation device (ACG) configured to generate an initial cloud of ultracold atoms associated with the first elementary sensor (SENA) and an initial cloud (CLB) of ultracold atoms associated with the second elementary sensor (SENB), with said initial clouds being located close to said XY-plane of said chip;
a generator (GB) for generating a uniform magnetic field (Bc);
a power supply device (PSD) comprising at least one microwave generator (GMW) and at least one direct current generator (GDC), the power supply device being configured to apply microwave signals to said waveguides and direct currents to said conductive elements;
the magnetic field generator and the power supply device being configured to apply the magnetic field, the direct currents and the microwave signals in a predetermined sequence;
with an arrangement of said group of one or more conductive elements and said sequence being configured, when implementing each sensor, to:
i) generate an initial trapping potential for said initial cloud of ultracold atoms defining a departure point;
ii) spatially separate the initial cloud into a first cloud (CL1A, CL1B) of ultracold atoms in a first internal state and a second cloud (CL2A, CL2B) of ultracold atoms in a second internal state, by respectively forming a first (T1A, T1B) and second (T2A, T2B) ultracold atom trap, and such that the first cloud, the second cloud and the departure point are aligned along a measurement axis;
iii) maintain the separation of said first and second traps for a time Ts, and then recombine said traps at said departure point, such that said first and second clouds respectively cover a first and a second linear trajectory parallel to the XY-plane from the departure point;
with the arrangement of said group of one or more conductive elements of each sensor and said sequence being further configured so that the trajectories (TR1A, TR2A) associated with the first elementary sensor and the trajectories (TR1B, TR2B) associated with the second elementary sensor are parallel to each other, are of the same length, are covered simultaneously and so that the departure direction of the first clouds, from the first and the second elementary sensor respectively, are opposite;
the sensor further comprising a detection system (SDET) adapted to measure at least a first phase (φ_{tot_SA}) of the first elementary sensor and a second phase (φ_{tot_SB}) of the second elementary sensor, with an acceleration being determined from a difference between the first and the second phase.

2. The sensor according to claim 1, wherein the power supply device PSD is further configured to apply direct currents to said waveguides.

3. The sensor according to claim 1, wherein the first and the second pair of waveguides are perpendicular to each other, and wherein the sensor comprises at least two assemblies configured to respectively carry out an acceleration measurement along two orthogonal axes.

4. The sensor according to claim 1, wherein the atom chip has a matrix structure, the pixels of which define potential elementary sensors, with a set comprising two pixels of the matrix.

5. The sensor according to claim 4, wherein sets of a first and a second elementary sensor have at least one conductive element in common.

6. An inertial unit comprising at least two accelerometer-type sensors according to claim 3 configured to respectively carry out an acceleration measurement along two orthogonal axes, with the matrix atom chip further comprising pixels configured to carry out at least one clock measurement and pixels configured to carry out rotation speed measurements along three orthogonal axes.

7. A method for measuring acceleration using an interferometric ultracold atom inertial sensor comprising an atom chip (ACh) placed in a vacuum chamber, comprising an XY-plane, called measurement plane, normal to a Z-axis, and comprising at least one set of a first and a second elementary sensor (SENA, SENB), with each elementary sensor comprising:
at least one first pair of waveguides (CPWX1, CPWX2) parallel to each other and at least one second pair of waveguides (CPWY′₁, CPWY′₂) parallel to each other and intersecting with the first pair;
a group of one or more conductive elements;
the method comprising the following steps:
A. generating an initial cloud of ultracold atoms associated with the first elementary sensor (SENA) and an initial cloud (CLB) of ultracold atoms associated with the second elementary sensor (SENB), with said initial clouds being located close to said XY-plane of said chip;
B. generating a uniform magnetic field;
C. generating, for each sensor, an initial trapping potential (Vini) for said initial cloud of ultracold atoms;
D. initializing, for each sensor, a first internal state and a second internal state via a first pulse π/2;
E. spatially separating, for each sensor, the initial cloud into a first cloud (CL1A, CL1B) of ultracold atoms in the first internal state and a second cloud (CL2A, CL2B) of ultracold atoms in the second internal state, by respectively forming a first (T1A, T1B) and second (T2A, T2B) ultracold atom trap, and such that the first cloud, the second cloud and the departure point are aligned along a measurement axis;
F. maintaining, for each sensor, the separation of said first and second traps for a time Ts, and then recombining said traps at said departure point, such that said first and second clouds respectively cover a first and a second linear trajectory parallel to the XY-plane from the departure point;
with steps B to F being carried out by applying, in a predetermined sequence, a uniform magnetic field, as well as direct currents to said conductive elements and microwave signals (I_{MW}) to said waveguides;
with the arrangement of said group of one or more conductive elements and said predetermined sequence being further configured so that the trajectories (TR1A, TR2A) associated with the first elementary sensor and the trajectories (TR1B, TR2B) associated with the second elementary sensor are parallel to each other, are of the same length, are covered simultaneously and so that the departure direction of the first clouds, from the first and the second sensor respectively, are opposite;
G. recombining said first and second internal states by applying a second pulse π/2 to said ultracold atoms;
H. measuring at least a first phase (φ_{tot_SA}) of the first elementary sensor and a second phase (φ_{tot_SB}) of the second elementary sensor, with an acceleration being determined from a difference between the first and the second phase.

8. The method according to claim 7, wherein step C comprises applying direct currents in at least one conductive element.

9. The method according to claim 7, wherein step E and step F involve applying microwave signals in a pair of waveguides in order to measure an acceleration along a measurement axis perpendicular to the waveguides of said pair.

10. The method according to claim 9, wherein in step E and step F applying microwave signals comprises:
for the first elementary sensor, applying a signal of frequency ωₐ in one of the waveguides and applying a frequency ω_{b} in the other waveguide;
for the second sensor, applying a signal of frequency ω_{b} in one of the waveguides and applying a frequency ωₐ in the other waveguide;
with said frequencies ωₐ and ω_{b} being determined from the resonant frequencies of said first and second internal states.

11. The method according to claim 6, wherein step F comprises a sub-step of cutting off microwave signals and a sub-step of applying direct currents to said waveguides.
